(19) United States
(12) Patent Application Publication
(10) Pub. No.: US 2008/0286579 A1
(43) Pub. Date: Nov. 20, 2008

(54) METHOD FOR IDENTIFICATION OF EQUIPMENT

(75) Inventor: Lon Black, Boulder, CO (US)

Correspondence Address: MARSH, FISCHMANN & BREYFOGLE LLP, 8055 East Tufts Avenue, Suite 450, Denver, CO, 80237, US

(73) Assignee: Boulder Based Designs Inc., Boulder, CO (US)

(21) Appl. No.: 12/119,071

(22) Filed: May 12, 2008

Related U.S. Application Data
(60) Provisional application No. 60/930,427, filed on May 16, 2007.

(51) Int. Cl. B32B 15/092; B05D 3/02; B05D 5/10; C08G 65/08

(52) U.S. Cl. 428/418; 427/372.2; 427/386; 427/207.1; 524/612

(57) ABSTRACT

A method and kit for the personal identification of a piece of equipment. An identifying mark having a pre-selected color is applied to a surface of the piece of equipment. The identifying mark is strongly adhered to the surface and has a high abrasion resistance and impact resistance. The identifying mark can be formed from an epoxy resin, such as a two-part epoxy resin. The piece of equipment can be recreational equipment, carpenter's tools or mechanic's tools.

### CROSS-REFERENCE TO RELATED APPLICATIONS

This application claims priority to U.S. Provisional Patent Application Ser. No. 60/930,427, entitled “METHOD FOR MARKING ITEMS”, and filed May 16, 2007, the disclosure of which is incorporated herein by reference in its entirety.

### BACKGROUND OF THE INVENTION

1. Field of the Invention

This invention relates to the field of marking items of equipment so that the equipment can be identified as belonging to a person or belonging to a specific group of equipment. The equipment can include, for example, hand tools or climbing gear.

2. Description of Related Art

A common problem exists where owners of equipment often need to uniquely distinguish their equipment from similar equipment owned by others. For example, rock climbers use many pieces of various types of gear such as carabiners, spring-loaded camming devices, chocks, etc. in order to ascend rock faces. The rock climbing gear is typically made of aluminum and sometimes consists of various metal alloys in order to impart desired physical characteristics. Rock climbers typically climb with a partner or partners, and these partners also own rock climbing gear, which is often similar or identical. Hence, the problem inevitably arises when climbers get confused as to who owns certain pieces of gear.

Most climbers tend to address this problem by marking their climbing gear, backpacking gear, and similar equipment with colored electrical tape. For example, Trango (Louisville, Colo.) has marketed colored electrical tape, so climbers can choose a preferred color and adhere the tape to the gear to distinguish their gear from the gear of others. Unfortunately, this method of marking one's gear requires the user to repeatedly mark the climbing gear because the rigorous use of the gear inherently removes the tape due to the piece of gear rubbing against rock and against other gear. Depending on how often the rock climber climbs, he or she may have to mark their gear up to four times a year to ensure that the mark is easily visible. Also, the color of tape used by one climber is often the same color of tape used by other climbers resulting in the same original problem of determining gear ownership.

Some climbers have stamped metal rock climbing gear with their initials or other indicia to mark the gear and, therefore, identify the gear. Unfortunately, stamping can weaken the structural integrity of the climbing gear and climbing gear manufacturers often void their warranties if the gear owner marks the gear in this fashion. Further, the stampings are difficult to identify without a close inspection of the gear.

Similarly, owners of typical mechanics and carpenter's tools have marked their tools by stamping the metal with initials to permanently mark the tool. Unfortunately, this method of identification is also difficult to see unless one examines each tool closely for identification. This method also requires the use of special metal stamping equipment.

U.S. Pat. No. 1,984,839 by Murray discloses hand tools or machine tools that are provided with one or more recesses and/or protuberances on their surfaces. These features that are adapted for the reception of a coloring medium or colored substance, such as paint or enamel, to provide a single color or a combination of colors for indicating the size of the tool or for identifying the tool itself.

U.S. Pat. No. 4,671,916 by Hamas discloses a method for identifying instruments such as surgical instruments by forming at least one bore in the instrument and placing a colored plug of material within the bore. The material selected for the plug should be autoclavable and examples of such materials include thermoplastics, polycarbonates, elastomers and most metals.

U.S. Pat. No. 4,841,653 by Negley discloses a method for the identification of work pieces such as wrenches by providing a unique color marking that permits a desired wrench to be selected from a group of wrenches. The marking can be a color code provided by a single band of colored tape affixed to the work piece.

U.S. Pat. No. 5,330,230 by Craig discloses a kit for identifying individually sized objects to facilitate their visual identification. The kit includes a predetermined number of colored bands or strips that can be adhesively affixed onto a particular object. The color of each band correlates to an object size, which is expressed on a master legend.

U.S. Pat. No. 5,762,796 by Zraik discloses a filter element that includes a cylindrical support tube and a pleated filter material surrounding the support tube. A mass of adhesive is applied along the axial length of the pleated filter element to encapsulate and retain the ends of the pleated filter so that the pleated filter is fixed to the support tube. Color and/or alphanumeric characters representing a structural or functional characteristic of the filter element can be included with the adhesive. The color can be introduced into the adhesive as a dye or pigment before curing, or can be applied as a dye or a paint to the exterior surface of the adhesive after the adhesive is cured.

U.S. Pat. No. 6,223,440 by Rashman discloses autoclavable medical instruments manufactured with colored synthetic handles of sufficient heat resistance to allow autoclaving. The color coding of the handles assists in the segregation of instruments by a medical facility.

U.S. Pat. No. 6,520,188 by Carter-Williams discloses a method for retrofitting a tool such as a curling iron with identifying indicia. The identifying indicia can include a cap that carries the identifying indicia in the form of a selected color or combination of colors.

U.S. Pat. No. 6,792,831 by Crosser discloses tools such as wrenches that provide one color instant identification of the tools. In one embodiment, a colored appliqué band or sleeve can be applied on the outer surface of the tools.

There remains a need for consumers to visually distinguish their gear and equipment from the gear and equipment of others by marking their gear with an identifying mark. The means for identifying the gear or equipment should be relatively inexpensive and easy for a consumer to use, and should be difficult to remove, either accidentally or purposefully, once it is applied to the gear.

### SUMMARY OF THE INVENTION

It is an object of the present invention to resolve identification problems by applying a colored identifying mark to multiple pieces of equipment. The identifying mark can have a very high abrasion and impact resistance and strong adherence to the equipment so that it resists being damaged and resists attempts to remove the mark. The identifying mark can be long lasting without compromising the structural integrity and utility of the equipment.

Thus, the present invention relates to a method for the identification of a piece of equipment, including multiple pieces of equipment. The method can include applying an agglutinant onto a visible surface of a piece of equipment and curing the agglutinant to form an identifying mark on the equipment. The agglutinant can include a sufficient quantity of a colorant to impart a pre-determined color to the identifying mark so that each piece of equipment can be visibly identified by the colored identifying mark. The same agglutinant can be applied to multiple pieces of equipment by the user to signify that each piece belongs to a particular set of equipment.

The present invention also relates to a method for the identification of a piece of equipment that includes applying a two-part epoxy resin onto a visible surface of the piece of equipment, where the two-part epoxy resin has a working viscosity of at least about 50,000 centipoise. The two-part epoxy resin is cured to form an identifying mark on the piece of equipment. The two-part epoxy resin includes a sufficient quantity of a colorant to impart a pre-determined color to the identifying mark such that the equipment can be visibly identified by the colored identifying mark.

The present invention also relates to a kit for marking a piece of equipment such that the individual pieces of equipment can be visually identified. The kit can include an epoxide polymer and a hardener for the epoxide polymer, where at least one of the epoxide polymer and the hardener comprises a sufficient quantity of a colorant to impart a color to the epoxy resin identification mark after the mark has fully cured. The epoxide polymer and the hardener can have a working viscosity of at least about 100,000 centipoise when mixed in a 50:50 ratio.

The present invention also relates to a tool having at least one exposed metal surface and a colored identifying mark adhered to the exposed metal surface, where the identifying mark is formed from a cured epoxy resin. The cured epoxy resin can have a T-peel strength of at least about 5 lbs per inch and a Shore D hardness of at least about 80 immediately after fully curing.

### DESCRIPTION OF THE DRAWINGS

FIG. 1 is a flow sheet illustrating a method according to an embodiment of the present invention.

FIG. 2 is a perspective side view of a carabiner that is marked with an identifying mark in accordance with an embodiment of the present invention.

FIG. 3 is an elevational side view of an anchoring device that is marked with an identifying mark in accordance with an embodiment of the present invention.

FIG. 4 is an elevational side view of a hammer that is marked with an identifying mark in accordance with an embodiment of the present invention.

### DESCRIPTION OF THE INVENTION

The present invention relates to the identification of individual pieces of equipment belonging to a particular set of equipment using a colored identifying mark. As used herein, the term equipment refers to any apparatus, machine or tool that is used for a particular kind of work or activity. By way of example, equipment can include household equipment such as audio-visual equipment and recreational equipment such as golf clubs or other sporting goods. Equipment can also include portable electronic devices such as cameras, cellular phones and music players (e.g., the I-POD music player available from Apple Computers).

One particular example of recreational equipment is climbing equipment owned by rock climbers or ice climbers, including, but not limited to, carabiners, camming devices, nuts and hexes that are utilized to ascend rock or ice faces. Recreational equipment can also include other equipment utilized by outdoor enthusiasts such as camping equipment, for example, portable cooking equipment. In another particular example, equipment includes tools, such as mechanic's tools and carpenter's tools. For example, mechanic's tools can include, but are not limited to, wrenches, pliers, screw drivers, socket sets, and the like, including manual tools or power tools. Carpenter's tools can include, but are not limited to, wrenches, hammers, pliers, saws, drills, drill bits, screwdrivers, wood-working equipment and the like. In one embodiment, the equipment includes an exposed metal surface, such as an aluminum surface, steel surface or chrome surface, onto which the identifying mark is applied.

The present invention is directed to the identification of pieces of such equipment using an identifying mark having a pre-determined color to signify ownership of the equipment or to signify that the pieces belong to a particular set of equipment. The identifying mark can have a strong adherence to the surface upon which it is placed, and can have good abrasion resistance and good impact resistance to resist accidental removal of the mark from the equipment. It is also difficult to intentionally remove the identifying mark, thereby deterring equipment theft.

The identifying mark can be placed on the piece of equipment after acquisition of the piece of equipment. That is, an identifying mark can be placed onto the pieces of equipment by the end-user so that the end-user can personally identify the pieces of equipment. Preferably, the identifying mark is placed on a surface of the equipment such that the identifying mark is readily observable. The identifying marks will typically not serve any structural function, such as by joining two components together, but will merely serve to identify the pieces of equipment.

Each identifying mark can be placed on an exposed outer surface of the piece of equipment so that the piece of equipment can be visibly and readily identified by cursory observation. In this regard, the identifying mark can have a pre-selected color to assist in identification of the equipment. For example, the identifying mark can reflect light having a primary wavelength in the range of from about 380 nm to about 750 nm, that is, within the visible spectrum. For example, the identifying mark can reflect one of the primary colors (red, green or blue) or one of the complementary colors (yellow, cyan or magenta). The identifying mark can also be black, white, brown or any other color. The identifying mark can be partially translucent or can be substantially opaque provided that the mark is sufficiently colored such that the mark can be easily observed. The colored identifying mark can also comprise more than one color, such as where particles or platelets having a first color are dispersed throughout a matrix having a second color.

The identifying mark can also be placed on the surface of the equipment in a predetermined and personalized shape or pattern that is selected or created by the user, and can also comprise more than one separate mark on each piece of equipment. In this manner, even if two equipment owners utilize the same color or a similar color to identify their equipment, the use of personalized shapes or patterns can further distinguish among the pieces of equipment. For example, a user can choose to apply an identifying colored mark that consists of the user's initials.

The identifying mark on the surface of the equipment can also have an appreciable thickness. That is, the identifying mark can advantageously be thicker than a mark or other indicia that is applied to a surface using a paint, ink or similar low viscosity flowable material. Having an appreciable thickness enhances the visibility of the identifying mark, particularly from a distance or from a viewing angle that is nearly in-plane with the marked surface of the tool. According to one embodiment, the identifying mark has a thickness of at least about 250 μm, such as at least about 500 μm, or at least about 750 μm. Further, the thickness should typically not exceed a thickness that would interfere with the ordinary use of the equipment, such as about 6 mm or more. An increased thickness as compared to thinner materials can also advantageously increase the ultra-violet (UV) resistance of the identifying mark. This can be particularly important for equipment that is subject to prolonged exposure to the sun, such as outdoor recreational equipment.

The identifying mark is also physically robust so that the identifying mark cannot be easily removed from a piece of equipment, either intentionally or accidentally. Many pieces of equipment such as climbing equipment, carpenter's tools or mechanic's tools are subject to conditions during normal use that can damage materials that may be applied to the piece of equipment, such as paint or tape. However, the identifying mark in accordance with the present invention can be capable of withstanding such rigors so that the piece of equipment does not require constant re-marking by the owner.

In this regard, the identifying mark is strongly adhered to the underlying equipment surface. The underlying equipment surface upon which the identification mark is applied can be virtually any type of surface. For many pieces of equipment such as climbing equipment or tools, the surface will be a hard metal surface, such as an aluminum surface, a steel surface or a chrome surface. In this regard, the identifying mark can have a T-peel adhesion value (as measured in accordance with ASTM D-1876) of at least about 3 lbs per inch width and more preferably at least about 5 lbs per inch width at 77° F. Such a high adhesion will ensure that the identifying mark resists removal from the surface to which it is applied.

The identifying mark can also have good abrasion resistance to resist accidental or intentional attempts to remove the mark by abrading the mark. In this regard, the identifying mark can have a relatively high Durometer hardness. A durometer measures the penetration of a specific indentor into a material under specified conditions of force and time. For example, the identifying mark of the present invention can have a Shore D hardness (as measured in accordance with ASTM D2240) immediately after fully curing of at least about 70 and more preferably at least about 80.

The identifying mark also can have a high impact resistance to resist chipping of the mark. Further, the identifying mark can be highly resistant to degradation due to ultraviolet (UV) light exposure. Many materials such as paints or epoxy resins that are exposed to UV light (e.g., the sun) for an extended period of time experience a significant degradation in physical properties of the material. However, it has been found that the identifying mark in accordance with the present invention has improved resistance to UV degradation. It is believed that the resistance to UV degradation is due in part to the use of colorants in the mark, as well as the thickness of the mark.

The identifying mark can also be resistant to chemical degradation. That is, the identifying mark can be resistant to degradation due to exposure to oils, greases, anti-freeze compounds or other chemicals that may come into contact with the identifying mark. This aspect can be particularly important when the identifying mark is disposed on a mechanic's tool that is exposed to such chemicals.

The present invention is also directed to methods for applying identifying marks to pieces of equipment. As is noted above, the identifying mark can be applied to a piece of equipment by an end user after acquisition of the equipment, so that the end user can mark their various pieces of equipment with the same color mark and/or with the same pattern to personally identify the equipment.

For example, an identifying mark can be applied to a piece of equipment by applying an agglutinant onto an exposed surface of the piece of equipment and curing the agglutinant to form an identifying mark on the equipment. In one embodiment, the agglutinant is a two-part epoxy resin comprising an epoxide polymer as the first part and a hardener (catalyst) for the epoxide polymer as a second part. Thus, when the epoxide and the hardener are mixed the resulting epoxy resin can be applied to the equipment and cured to form the identifying mark. The epoxy resin can advantageously be applied onto a visible (exposed) surface of the piece of equipment such that the piece of equipment can be visibly and readily identified by the color of the identifying mark and/or the shape of the identifying mark on the equipment. In this regard, after placing the identifying mark on the piece of equipment, it is preferred that no other component of that piece is placed in contact with the epoxy to adhere the component. In this manner, the identifying mark is readily observed on the surface of the equipment.

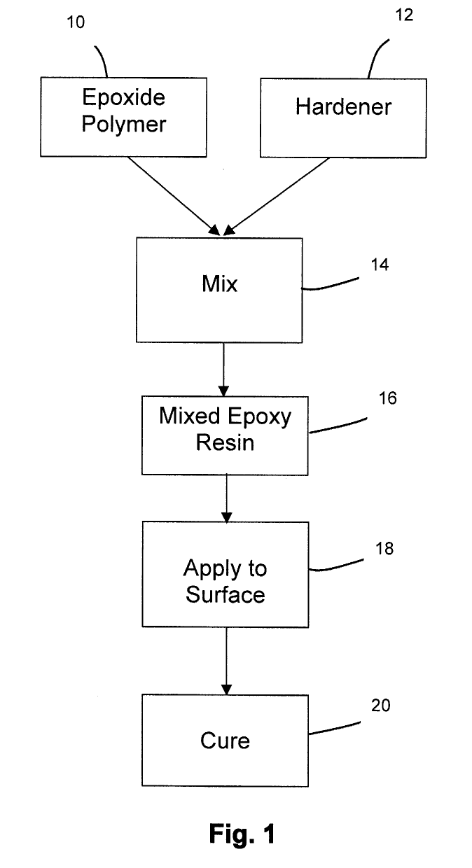

FIG. 1 is a flow sheet illustrating a method for the identification of a piece of equipment using a colored identifying mark. In this illustration, a two-part epoxy resin includes an epoxide polymer 10 and a hardener 12. The epoxide polymer 10 and hardener 12 are mixed 14 to form a substantially uniform epoxy resin composition 16. Before the mixed composition 16 has sufficient time to cure, the composition is applied 18 to a surface of the piece of equipment. After application of the composition to the equipment, the composition is cured 20 to form an identifying mark.

The epoxide polymer 10 can be, for example, a modified bisphenol epoxy resin. The epoxide polymer preferably has a high solids loading, such as greater than about 90% and the epoxide polymer can even comprise about 100% solids. The epoxide polymer can also have a low VOC content.

The epoxide polymer is mixed with a hardener 12, sometimes referred to as a catalyst or a curing agent, to form the epoxy resin composition 16. The hardener 12 reacts with the epoxide polymer to form the epoxy resin. In one embodiment, the hardener is an unsaturated fatty acid, which can optionally be mixed with an amine such as triethylene tetraamine. Such an epoxide polymer and hardener can be obtained from Polymer Composites, Inc. of Ontario, Calif.

Most epoxide polymers of this nature are essentially colorless and translucent in appearance. While the hardener can sometimes exhibit a natural light color such as amber, the mixed epoxy resin has a low opacity and becomes substantially colorless and translucent when the epoxy resin is fully cured.

In order to obtain an identifying mark having a preselected color, at least one of the hardener 12 or the epoxide polymer 10 can include a sufficient amount of a colorant to impart a readily identifiable color to the mixed composition when it is fully cured. In this regard, it is typically preferred that a colorant be included with the epoxide polymer 10. The colorant can be, for example, a dye or other organic or inorganic compound that can mix with the epoxy polymer 10 and impart a sufficient amount of color to the cured epoxy resin without degrading the properties of the cured epoxy resin. Examples of such colorants include organic or inorganic pigments. The amount of colorant that should be added to the epoxide polymer 10 can be determined by quantitatively or qualitatively measuring the opacity of the mixed composition until a desired opacity is achieved. The colorant can be mixed with an epoxide polymer using, for example, a planetary mixer operating at a relatively low speed so as not to induce air into the epoxide polymer. Alternatively, the colorant can be mixed with the hardener in a similar manner.

The epoxide polymer and hardener are mixed 14 to form a homogenous and substantially uniform epoxy resin composition, typically in about a 50:50 ratio. The working time of the epoxy resin composition should be sufficient to enable a user to place an identifying mark on a number of pieces of equipment before the epoxy resin begins to cure and becomes too viscous to easily apply to the equipment. In one embodiment, the working time for the mixed epoxy resin is at least about 30 minutes and more preferably is at least about 60 minutes.

The epoxy resin also has a relatively high viscosity when initially mixed, particularly as compared to paints, inks or similar low viscosity materials. This provides a number of advantages. For example, it is not desirable to have the mixed epoxy resin composition flow into or near moving parts of the equipment. It is also often desirable to mark a surface of the equipment that is not perfectly flat or is vertically oriented, and a high viscosity will enable such a surface to be marked using the desired pattern. Further, a relatively high viscosity can result in an identifying mark having an appreciable thickness, as is discussed above.

In this regard, it is preferred that the viscosity of the mixed epoxy resin immediately after thorough mixing of the epoxide polymer and the hardener in a volume ratio of about 50:50 can be at least about 50,000 centipoise, such as at least about 100,000 centipoise and even at least about 125,000 centipoise. The mixed epoxy resin can also be thixotropic so that the composition is flowable when being applied to a surface but sets on a surface without losing the shape of the applied pattern. In this regard, the vertical flow of the epoxy resin can be not greater than about 0.2 inch per 10 grams at 900 until cure (measured at 77° C.).

As described above, the epoxide polymer and/or the hardener can include a colorant. It is also possible to provide a colorant to the mixed epoxy resin after or during the mixing step. For example, a translucent epoxide polymer and hardener can be mixed and a colorant can be added to the mixture to form a desired color. This can also facilitate the provision of several different colorants in a kit with the epoxy resin components to provide the user with the ability to utilize more than one color or to produce custom colors.

The mixed epoxy resin is applied to a surface of the piece of equipment. Preferably, the mixed epoxy resin is applied to an exposed surface such that the identifying mark is readily and easily observable during normal use of the piece of equipment. In this regard, it should be noted that the mixed epoxy resin is preferably not used to adhere two or more components together, but rather serves the sole function of identifying the piece of equipment.

Prior to application of the mixed epoxy resin to the surface of the piece of equipment, it is also possible to perform surface preparation of the piece of equipment to enhance the adherence of the mixed epoxy resin to the piece of equipment. In this regard, a metal surface could be abraded such as by sandblasting or could be chemically etched to improve adherence of the mixed epoxy resin to the surface. For example, acids such as formic acid can be used to selectively etch a chrome surface to enhance the adherence of an epoxy resin to the chrome surface.

After application of the mixed epoxy resin to the surface of the piece of equipment, the epoxy resin is cured to form an identifying mark. Preferably, the curing of the epoxy resin can occur at room temperature. However, it is also possible to accelerate the curing such as by mildly heating the mixed epoxy resin.

The foregoing process can be repeated by a user to mark many different pieces of equipment to signify that the pieces belong to a set, such as a set of equipment that is owned by the individual.

The present invention also relates to a kit for applying identifying marks to pieces of equipment. The kit can include a two-part epoxy resin including an epoxide polymer and a hardener, as is described above. The two components of the epoxy resin are provided separately to enable the user to mix and apply the epoxy resin. The two components can be disposed, for example, in a double-barreled syringe that can dispense approximately equal amounts by volume of the two compounds. At least one of the two components can include a colorant. The kit can also include stencils or other means for making patterns on the surface of the equipment.

FIGS. 2-4 illustrate various pieces of equipment that include an identifying mark in accordance with the present invention. FIG. 2 illustrates a perspective left-side view of a carabiner marked in accordance with the present invention. Carabiners are used in rock climbing and similar activities. The carabiner illustrated in FIG. 2 is similar to those referenced in U.S. Pat. No. 4,811,467 and U.S. Pat. No. 4,095,316, which are incorporated herein by reference in their entireties. Carabiners have areas known as a spine 211, a gate 212, and a gate origin 213. Identifying mark 221 is an example of a unique mark the owner of the carabiner can apply to the carabiner to identify the carabiner. As illustrated in FIG. 2, the identifying mark 221 is in the form of two ovals just below the gate origin 213. Identifying mark 225 is another example of a unique mark, namely two diagonally positioned lines along the carabiner spine 211. The variety of positions and types of identifying marks available to the owner of the carabiner enhance the effectiveness of the present invention by allowing the owner to create easily visible and unique marks to identify the piece of gear. These unique marks signify ownership to others that might mistake the owner's carabiner for one of their own.

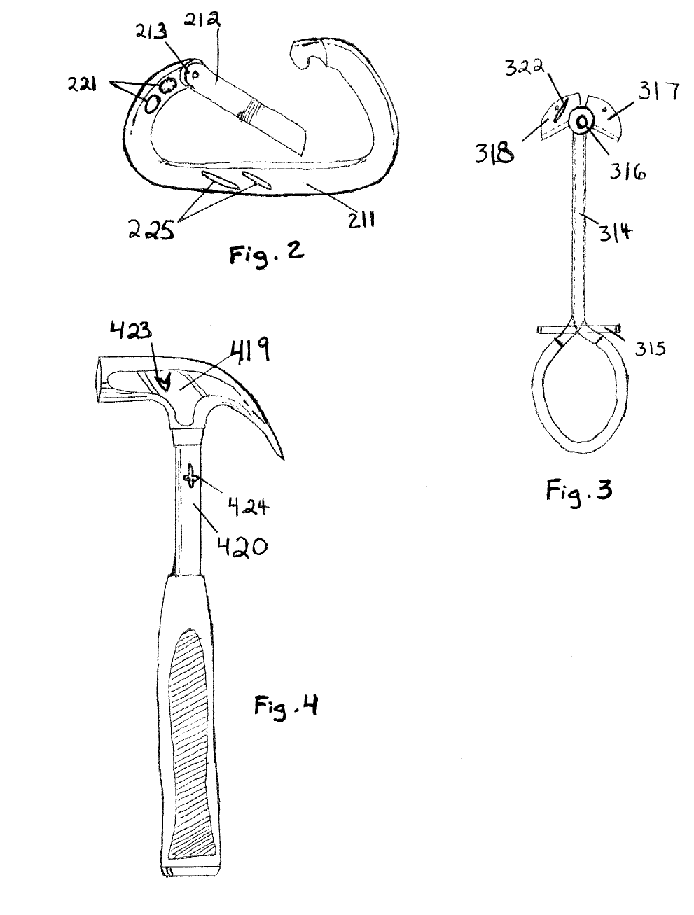

FIG. 3 is an elevational side view of a typically shaped anchoring device utilized by climbers that includes an identification mark in accordance with the present invention. The anchoring device in FIG. 3 is used in rock climbing and is similar to those referenced in U.S. Pat. No. 4,832,289 and U.S. Pat. No. 6,736,359, which are each incorporated herein by reference in their entireties. Anchoring devices have common parts known as a trigger sheath 314, a trigger plate 315, a cam member axle 316, a right cam member 317, and a left cam member 318. Identifying mark 322 is an example of a unique mark the owner of the anchoring device can apply to the left cam member 318 in the shape of a diagonal line resulting in an easily identifiable mark signifying ownership of the anchoring device and distinguishing the anchoring device from other anchoring devices. Similarly, the owner of the anchoring device could apply an identifying mark to the right cam member 317, the cam member axle 316, or the trigger plate 315 as the owner desires. The variety of positions and types of marks available to the owner of the anchoring device enhance the effectiveness of the invention by increasing uniqueness and visibility of the owner's mark.

FIG. 4 is an elevational side view of a tool, namely a hammer, that is marked in accordance with the present invention. The hammer in FIG. 4 is a typically shaped carpenters hammer similar to hammers referenced in U.S. Design Patent No. D325,863 and U.S. Design Patent No. D275,261, each of which is incorporated herein by reference in its entirety. Hammers have similar areas like a hammer head 419 and a head shaft 420. The identifying mark on the hammer head 419 is a unique mark 423 in the shape of an upside down V. The identifying mark on the hammer shaft 420 is another example of a unique mark in the shape of a cross 424 available to the owner of the hammer allowing the ability to easily identify his tool from other similar tools thereby reducing the chance of another person mistaking ownership of the hammer.

While I have described my invention with one possible form or embodiment thereof, it is to be understood that the present disclosure is illustrative rather than restrictive regarding the invention, and that improvements and modifications may be resorted to without departing from the spirit of the invention or the scope of the claims which follow.

What is claimed is:

1. A method for the identification of a piece of equipment, comprising the steps of:
applying an agglutinant onto an exposed metal surface of at least a first piece of equipment; and
curing the agglutinant to form an identifying mark on the piece of equipment,
where the agglutinant comprises a sufficient quantity of a colorant to impart a pre-determined color to the identifying mark such that the piece of equipment can be visibly identified by the colored identifying mark.

2. A method as recited in claim 1, wherein said agglutinant is a two-part epoxy resin.

3. A method as recited in claim 2, wherein said colored identifying mark has a T-peel adhesion of at least about 3 lbs per inch width at 77° F. when fully cured.

4. A method as recited in claim 2, wherein said colored identifying mark has a Shore D hardness of at least about 70 immediately after fully curing.

5. A method as recited in claim 2, wherein a first part of the two-part epoxy resin comprises a modified bisphenol epoxy resin and a second part comprises a hardener for the epoxy resin.

6. A method as recited in claim 1, wherein said colored identifying mark reflects light having a wavelength in the range of from about 380 nm to about 750 nm.

7. A method as recited in claim 1, wherein said agglutinant has a working viscosity of at least about 50,000 centipoise.

8. A method as recited in claim 1, wherein said piece of equipment is a piece of climbing equipment.

9. A method as recited in claim 1, wherein said piece of equipment is a mechanic's tool.

10. A method as recited in claim 1, wherein said piece of equipment is a carpenter's tool.

11. A method as recited in claim 1, wherein said metal surface is selected from an aluminum surface, a steel surface and a chrome surface.

12. A method as recited in claim 1, further comprising the step of forming a similar identifying mark on a second piece of equipment using the agglutinant.

13. A method for the identification of a piece of equipment, comprising the steps of:
applying a two-part epoxy resin onto a visible surface of at least a first piece of equipment, where the two-part epoxy resin has a working viscosity of at least about 50,000 centipoise; and
curing the two-part epoxy resin to form an identifying mark on the piece of equipment,
where the two-part epoxy resin comprises a sufficient quantity of a colorant to impart a pre-determined color to the identifying mark, and where the piece of equipment can be visibly identified by the colored identifying mark.

14. A method as recited in claim 13, wherein said colored identifying mark has a T-peel adhesion of at least about 3 lbs per inch width at 77° F. when fully cured.

15. A method as recited in claim 13, wherein said colored identifying mark has a Shore D hardness of at least about 70 immediately after curing.

16. A method as recited in claim 13, wherein said colored identifying mark reflects light having a wavelength in the range of from about 380 nm to about 750 nm.

17. A method as recited in claim 13, wherein said two-part epoxy resin has a working viscosity of at least about 100,000 centipoise.

18. A method as recited in claim 13, wherein said piece of equipment is selected from a carpenter's tool or a mechanic's tool.

19. A method as recited in claim 13, further comprising the step of forming a similar identifying mark on a second piece of equipment using the two-part epoxy resin.

20. A kit for marking a piece of equipment such that the individual pieces of equipment can be visually identified, the kit comprising:
an epoxide polymer; and
a hardener for the epoxide polymer,
where the epoxide polymer and the hardener have a working viscosity of at least about 100,000 centipoise when mixed in about a 50:50 volume ratio and where at least one of the epoxide polymer and the hardener comprises a sufficient concentration of a colorant to impart a color to the epoxy resin mark after the mark has fully cured.

21. A kit as recited in claim 20, wherein said epoxide polymer and said hardener are disposed in a double-barrel syringe.

22. A kit as recited in claim 20, wherein said epoxide polymer and hardener can be mixed and cured to a Shore D hardness of at least about 70.

23. A tool having at least one exposed metal surface and a colored identifying mark adhered to the exposed metal surface, where the identifying mark comprises a cured epoxy resin having a T-peel adhesion of at least about 5 lbs per inch width at 77° C. and a Shore D hardness of at least about 80 immediately after fully curing.

24. A tool as recited in claim 23, wherein said identifying mark reflects light having a wavelength in the range of from about 380 nm to about 750 nm.

25. A tool as recited in claim 23, wherein said tool is selected from a carpenter's tool or a mechanic's tool.
